(19) United States
(12) Patent Application Publication
(10) Pub. No.: US 2026/0348871 A1
(43) Pub. Date: Nov. 5, 2026

(54) DEVICE FOR DETECTING DEFECTS IN A PACKAGING UNIT AND/OR A PRODUCT

(71) Applicant: MULTIVAC MARKING & INSPECTION GMBH & CO. KG, Enger (DE)

(72) Inventors: Dennis ISAAK, Bielefeld (DE); Daniel SIEKMANN, Enger (DE)

(73) Assignee: MULTIVAC MARKING & INSPECTION GMBH & CO. KG, Enger (DE)

(21) Appl. No.: 19/662,758

(22) Filed: Apr. 29, 2026

(30) Foreign Application Priority Data
Apr. 30, 2025 (DE) 102025116757.5
Oct. 6, 2025 (DE) 102025140602.2

(51) Int. Cl. G01N 21/90; G06T 7/00; G06T 7/11; G06T 7/136

(52) U.S. Cl. CPC G01N 21/9054; G06T 7/0008; G06T 7/11; G06T 7/136; G01N 2201/0438; G01N 2201/06126; G06T 2207/10048

(57) ABSTRACT

A device for detecting defects in a packaging unit and/or a product includes an infrared light source, an infrared detector, and an evaluation unit. The infrared detector and the infrared light source are arranged such that the infrared detector can capture an image of a packaging unit and/or a product in reflected light and/or transmitted light. The evaluation unit is to process the image and to evaluate the processed image by way of a region detection algorithm and to determine whether a group of contiguous regions in the processed image has, for each region, an image value above or below a threshold value, and to output information indicative of a defect when at least one group of contiguous regions is present in the processed image for which each region has an image value above or below the threshold value.

### CROSS-REFERENCE TO RELATED APPLICATIONS

This application claims foreign priority benefits under 35 U.S.C. § 119(a)-(d) to German Patent Application No. 102025116757.5 filed on Apr. 30, 2025 and to German Patent Application No. 102025140602.2 filed on Oct. 6, 2025, the disclosures of which are hereby incorporated herein by reference in their entireties.

### TECHNICAL FIELD

The present disclosure relates to a device for detecting defects in a packaging unit and/or a product as well as to a method for detecting defects in a packaging unit and/or a product.

### BACKGROUND

Devices and methods for inspecting packaging or products for defects are known from prior art. They typically comprise complex analyses such as, for example, hyperspectral analyses, radar imaging, or imaging methods using X-ray radiation. The devices used for this purpose, such as for example X-ray emitters, are expensive. At the same time, the evaluation of the captured image information is difficult and prone to errors.

### SUMMARY

Based on known prior art, the technical object to be satisfied is therefore to specify a device and a method for detecting defects in a packaging unit and/or products that can be realized inexpensively and at the same time detect defects as reliably as possible.

This object is satisfied according to the disclosure by the device for detecting defects in a packaging unit and/or a product as well as by a method for detecting defects in a packaging unit and/or a product as described herein. Advantageous further developments of the disclosure are also described herein.

Provided according to the disclosure is a device for detecting defects in a packaging unit and/or a product, the device comprising an infrared light source, an infrared detector, and an evaluation unit, wherein the infrared detector and the infrared light source are arranged such that the infrared detector can capture an image of a packaging unit and/or a product in reflected light and/or transmitted light, and wherein the evaluation unit is configured to process the image and to evaluate the processed image by way of a region detection algorithm and to determine whether a group of contiguous regions in the processed image has, for each region, an image value above or below a threshold value, and to output information indicative of a defect if at least one group of contiguous regions is present in the processed image for which each region has an image value above or below the threshold value.

A processed image is to be understood fundamentally to be any form of processing of the image that retains at least part of the image information or converts it in such a bijective manner that the original image information can be recovered. The processing of the image is therefore also to be understood to include “identical” processing, which comprises, for example, merely that the original image be translated into a (file) format that can be processed by the image processing algorithm. However, other forms of processing are also conceivable, for example, a defined increase or decrease of the contrast or a defined modification of color values or gray values of the original image to obtain the processed image. Not comprised by the term processed image are conceivable conversions of the image such that no original image information whatsoever is retained and/or such conversions in which the original image information is converted in an irreversible manner, i.e., in a manner that makes it impossible to back-calculate the original image information. The latter may include, for example, such conversions as are performed by neural networks in pattern recognition in images.

The image value is to be understood to be a value associated with a pixel of the processed image, such as a color value, a gray value, a brightness value, or the like. However, the image value can also be a value that is determined from the functional combination of image values of two pixels, such as nearest neighbors, for example, a difference of the above-mentioned image values of two pixels.

The device being configured to detect defects in a packaging unit and/or a product is to be understood in the sense of the disclosure such that the device can be used to detect defects in a packaging unit or defects in a product or defects in a packaging unit with a product introduced thereinto. Such defects can include, for example, defects of the product (insufficient quality of a food product or indications of spoilage of the food product) or defects in a closed packaging unit, such as for example defects in a seal seam due to product being present in the region of the seal seam or other contaminations being present in the region of the seal seam. However, the disclosure is not restricted with respect to the type of defects or the type of packaging or products.

The products can in principle be understood to be any products. However, preferred are in particular food products, such as, for example, sliced sausage or sliced cheese, as well as dough or products in the pharmaceutical industry, such as, for example, tablets, or medical devices, such as, for example, catheters, needles, or surgical instruments. The packaging into which these products can be filled or introduced can comprise, for example, flexible packaging (in particular foil pouches) or at least partially dimensionally stable or rigid packaging. Dimensionally stable packaging is to be understood such packaging that was produced at least in part using a deep-drawing machine. Such packaging typically comprises a deep-drawn packaging tray into which a product is placed and a cover film that was sealed to the packaging tray to close the packaging unit. At least the packaging tray is typically configured such that it retains its shape under the sole influence of gravity and without external action (with or without product being filled) and is therefore dimensionally stable in the above sense. Rigid packaging is to be understood to be such packaging that does not deform during normal use, in particular also retains its shape at least in part, for example, when a cover film of the packaging unit is opened An example of such a rigid packaging is a packaging unit that consists of a packaging tray made of plastic material and a sealing film, in professional circles also referred to as “trays” or “dishes.” The packaging tray is in this case typically produced by deep-drawing and therefore substantially rigid, whereas the sealing film is flexible or less rigid.

The regions in the sense of the disclosure can be understood to be a group of pixels. The number of pixels is not restricted and can also be 1, such that a region can be equal to one pixel of the processed image.

The region detection algorithm preferably processes only the processed image. A group of contiguous regions that are detected by the region detection algorithm is to be understood such that these regions are at least pairwise adjacent to one another in the processed image. If the processed image is represented as a matrix A with corresponding entries Aᵢⱼ for each pixel, this means that a group of regions is to be understood to be those regions in which at least two regions each correspond to matrix entries that are directly adjacent. This applies, for example, to regions or elements of the matrix Aᵢⱼ and Aᵢⱼ₊₁, but not to regions Aᵢⱼ and Aᵢⱼ₊₂, since these are separated from one another by the region or matrix element Aᵢⱼ₊₁. To this extent, the region detection algorithm examines the processed image as to whether there are groups of regions that are contiguous and at the same time the image value for each of these regions is above or below a defined threshold value.

The threshold value is to be understood to be that value that is regarded to be indicative of a defect being present in the region at issue. If the image values in the processed image are specified, for example, as (real) numbers between 0 and 1, it can be provided that, if the values are above a (for example empirically determined) threshold value of 0.6, a defect is present. Depending on which type of image value is being examined, however, it can also be provided that a defect is present when the image values fall below this threshold value. However, the disclosure is not restricted with respect to the threshold value and the choice of the threshold value (as well as the number of regions that must be present in the contiguous region) can depend on external conditions, such as, for example, an intention to sort out packaging rather due to falsely positively detected defects (false positive detection), than to take the risk that a packaging unit is further used despite an undetected defect (false negative detection).

With the device according to the disclosure, technically efficient determination of a defect is obtained, since the original image is examined directly for defects using a suitable region detection algorithm. Costs can be reduced with this configuration as well as with the use of an infrared image. In particular, the use of infrared light is advantageous, since this allows for an inspection of regions of the packaging unit that are opaque in the visible spectral range.

It can be provided that the processed image comprises at least part of the image information of the image. The image information in this case is the original image information, so that the processed image retains it at least in part. For example, the processed image can be an image whose resolution has been increased or reduced, but otherwise no modifications have been made. The original image information is retained in this case for at least some pixels. In this embodiment the processed image can also be identical to the original image with respect to the image information contained. With this embodiment, detection of defects can be effected in a reliable and reconstructable manner.

It can be provided that the image value is a gray value or a gray value difference of respectively adjacent pixels.

Since defects present themselves as regions of the image that typically differ from other regions of the image with respect to their characteristics in the infrared (product present or absent, different absorption and/or emission properties in the infrared and thus different gray values), reliable detection of defects in the packaging unit or the product can thus be achieved.

It can be provided that the region detection algorithm is a blob algorithm and/or a contrast detection algorithm. Blob algorithms and contrast detection algorithms are in principle known to the person skilled in the art. They are particularly suitable for identifying and evaluating contiguous regions according to certain criteria. Blob algorithms use a predefined threshold value and classify pixels or regions of the image according to whether they have an image value above or below this threshold value. Contrast detection algorithms compare directly adjacent regions with respect to a change in an image value (for example gray value). If this change exceeds a threshold value, a region of the image can thereby be delimited from another region. Contiguous pixels for which the image values differ by no more than the threshold value can then be detected by such a contrast detection algorithm as being part of a region.

An advantageous configuration of a contrast detection algorithm can be a pattern recognition algorithm, in particular an edge detection algorithm. It uses the described difference of image values of adjacent pixels (for example, a difference of gray values) to derive therefrom the presence of an edge (for example, within the product or the packaging). This edge need not be an actual edge (for example, an outer edge of the packaging unit), but in general represents a transition, present substantially along a line, of the properties of the packaging unit or the product in infrared light (for example, transmission or emission property). Such a transition may indicate a defect. If such an edge is detected by a respective pattern recognition algorithm, a defect can then be inferred at least in the region of the detected edge. In one embodiment it can also be provided that the pattern recognition algorithm, in particular an edge detection algorithm, is used to detect regions that are completely surrounded by corresponding edges. These regions can be detected as a defect if, for example, the detected edges all have, on the side facing toward the region, an image value that deviates from the region disposed outside and differs therefrom by a value greater than the corresponding threshold value. With this embodiment, the detection of regions or groups of regions that are part of a defect can be achieved by the detection of edges separating these regions from other regions that do not represent defects.

In one embodiment, it is provided that the defects comprise one of a defective part of a product, a defective part of a packaging unit, a defective seal seam. The present disclosure is particularly suitable for detecting such defects which can in particular advantageously influence the further processing of products and/or packaging units.

The regions can be identical, wherein the regions are optionally 16 pixels, 9 pixels, 4 pixels, or 1 pixel in size. The specific choice of the size of the regions can be particularly advantageous when defects can only be reliably detected, for example, with larger groups of pixels (larger regions) or when defects can be reliably identified even when considering individual pixels. That the regions have a size of pixels is to be understood such that, in the processed image, a determination is made for a contiguous group of pixels (thus for example rectangles or squares in the image).

It can be provided that the device comprises a transport device for transporting packaging and/or products and that the transport device is arranged and configured such that it guides packaging and/or products past the infrared light source and the infrared detector.

The transport device can be, for example, a conveyor belt on which the packaging and/or products are transported along a transport direction. Capturing the image by way of the infrared detector can be done either when transporting the packaging or products, or the transport device can be stopped for capturing the image. With this embodiment, a high throughput of packaging and/or products is possible.

In one embodiment, it is provided that the infrared light source is a diffuse infrared light source or that the device comprises a diffuser to generate diffuse reflected light and/or backlight and/or that the infrared detector comprises a camera, in particular, a short-wave infrared camera (SWIR camera). By using a diffuse light source, or respectively a diffuser to generate diffuse reflected light and/or backlight, the occurrence of reflections caused by point light sources or infrared sources can be prevented in the captured image, SWIR cameras are particularly advantageous for the high-resolution capture of the necessary infrared images.

According to the disclosure, a method for detecting defects in a packaging unit and/or a product by way of a device is furthermore provided, the device comprising an infrared light source, an infrared detector, and an evaluation unit, wherein the infrared detector and the infrared light source are arranged such that the infrared detector can capture an image of a packaging unit and/or a product in reflected light and/or transmitted light, the method comprising obtaining a processed image based on the image using the evaluation unit, and evaluating the processed image using the evaluation unit by way of a region detection algorithm of the evaluation unit and determining whether a group of contiguous regions in the processed image has, for each region, an image value above or below a threshold value, and to output information indicative of a defect if at least one group of contiguous regions is present in the processed image for which each region has an image value above or below the threshold value.

Inexpensive and at the same time reliable detection of defects is possible with this method.

It can be provided that the processed image comprises at least part of the image information of the image. As a result, the evaluation can be based substantially on the captured image, and it can thereby be prevented that information is lost. This ensures that defects are determined in a reliable manner.

The region detection algorithm can be a blob algorithm and/or a contrast detection algorithm. The contrast detection algorithm can advantageously be configured as a pattern recognition algorithm and in particular as an edge detection algorithm. These algorithms are particularly well suited for detecting contiguous regions based on certain criteria, presently of exceeding a threshold value.

It can be provided that the defects comprise one of a defective part of a product, a defective part of a packaging unit, a defective seal seam. The disclosure can thereby be advantageously applied to the food industry and the pharmaceutical and medical industry.

The regions can be identical, wherein the regions are optionally 16 pixels, 9 pixels, 4 pixels, or 1 pixel in size. With this embodiment, demand-dependent, reliable detection of regions that possibly have defects is possible.

It can be provided in one embodiment that the device comprises a transport device for transporting packaging and/or products and that the transport device is arranged and configured such that it guides packaging and/or products past the infrared light source and the infrared detector. As a result, throughput can be achieved with simultaneously reliable detection of defects.

In one embodiment it is provided that the infrared light source is a diffuse infrared light source or that the device comprises a diffuser to generate diffuse reflected light and/or backlight and/or that the infrared detector comprises a camera, in particular, a short-wave infrared camera (SWIR camera). With this embodiment, high-quality images can be generated which can improve the subsequent detection of defects.

### BRIEF DESCRIPTION OF THE DRAWINGS

FIG. 1 shows a device for detecting defects in a packaging unit and/or a product according to an embodiment.

FIG. 2 shows a flow diagram of a method for detecting defects in a packaging unit and/or a product.

### DETAILED DESCRIPTION

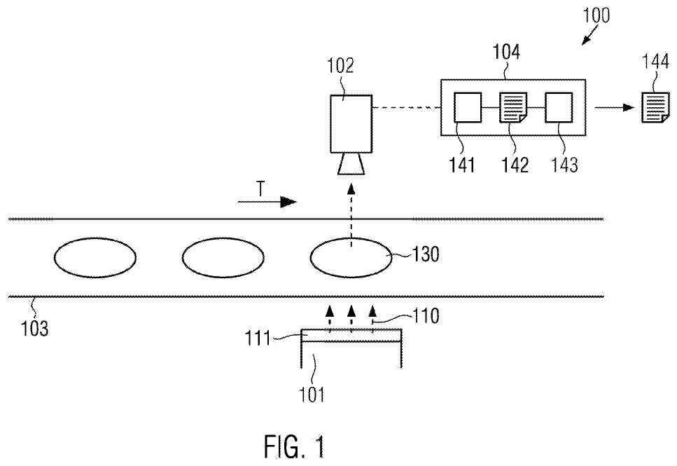

FIG. 1 shows a device 100 for detecting defects in a packaging unit and/or a product 130. Device 100 comprises an infrared light source 101 with which infrared light 110 can be emitted in the direction of a product and/or a packaging unit 130. Device 100 further comprises an infrared detector 102 that can detect the infrared light emitted and/or reflected by the packaging unit and/or the product 130, so as to generate an image, in particular an infrared image.

While the disclosure is not restricted to specific products or packaging, reference will be made hereinafter to the processing of an image of a product solely for the purpose of simpler description. It is understood that all of the embodiments described in this context are also applicable to packaging units or packaging units with a product filled therein and are accordingly also explicitly provided for.

Device 100 can comprise a transport device 103 for the purpose of transporting products 130. Transport device 103 can be configured, for example, as a conveyor belt on which products 130 can be transported along a conveying direction T. However, transport device 103 is not restricted in this respect.

According to the disclosure, the device further comprises an evaluation unit 104 (for example in the form of a computer with an associated processor and memory with suitable program instructions for execution by the processor), with which an image captured by the infrared detector in reflected light and/or transmitted light (depending on the configuration of the infrared light source and the positioning thereof relative to the product and the infrared detector) can be evaluated. For this purpose, the evaluation unit first generates a processed image 142 based on the image captured.

The processed image in one embodiment can be substantially identical to the original image or can be processed such that at least part of the original image information is retained. If the processed image is substantially identical to the originally captured image, this can comprise, for example, that a data format is changed such that further processing of the image within the evaluation unit can take place if an algorithm for the processing of the image requires a format that differs from the original data format with which the image was generated.

If the image is processed such that at least part of the original image information is retained, it can be provided, for example, that color values or gray values are scaled by a factor, for example, to increase the contrast, and/or the resolution of the image is changed while retaining at least part of the original image information. Alternatively or additionally, it can also be provided that the originally captured image is cropped to generate the processed image, i.e., regions of the captured image are removed and/or replaced with pixels having standard values (for example having value 0 or 255 in a grayscale image), if it is known that these regions are irrelevant for the actual assessment of the packaging unit.

Processed image 142 is therefore not necessarily identical to the captured image, but comprises at least part of the original image information or has been modified at most such that a bijective association of at least one image value of at least part of the processed image to a corresponding image value of a corresponding part of the captured image still exists.

To generate this processed image, evaluation unit 104 can comprise, for example, an image processing program 141 that can modify the captured image according to predefined instructions or program instructions. It can be provided particularly advantageously that processing of the image allows for a more reliable detection of defects as compared to the captured image, for example, by amplifying contrasts or color differences in the processed image.

In this way, the evaluation unit generates a data structure based on the original image (for example in the form of a matrix) in which regions of the original image are unambiguously associated with processed or modified regions. The matrix can then in each entry have at least one image value (for example a color value or a contrast value) or also several of image values. As described, the processed image can have the shape of a matrix A, wherein the matrix entries Aᵢⱼ contain an image value. Each value Aᵢⱼ of the matrix therefore represents a region (in particular a pixel or a group of pixels) of the original image and unambiguously associates an image value thereto.

Evaluation unit 104 furthermore comprises a region detection algorithm 143 such as, for example, a blob algorithm or a contrast detection algorithm. Processed image 142 is made available to this region detection algorithm for further evaluation. According to the disclosure, the region detection algorithm can then determine based on the processed image whether a group of contiguous regions exists (i.e., regions of the original image with which an image value is respectively associated in the processed image) in which each region, i.e., each region of the contiguous regions, has an image value below and/or above a threshold value. The region detection algorithm can therefore examine whether contiguous or adjacent entries of matrix A respectively have image values that are above and/or below a threshold value. In the case of the embodiment of the region detection algorithm as a contrast detection algorithm, this examination can also or alternatively comprise that it be determined whether adjacent regions differ with respect to an image value by a threshold value, i.e., a difference between image values of regions be above and/or below a predefined threshold value. This embodiment is to be comprised by the above-described determination that contiguous regions have image values that are above and/or below a threshold value. This embodiment does not detect defects directly by way of detecting groups of contiguous regions, but implicitly by way of determining that regions, i.e., groups of contiguous regions, undergo a jump or strong change in the image value at their respective boundaries. This indicates a defect.

If the evaluation unit determines by way of the region detection algorithm that such a group of contiguous regions exists for which the image values are above and/or below a threshold value (or the difference of the image values of adjacent groups is above or below the threshold value), the evaluation unit can then detect that a defect is actually present and/or that it has a size that is relevant for further treatment of the product (for example making it necessary to sort out the product, such as by any type of sorter, e.g., pusher/paddle sorter, pop-up sorter, diverters/gates, activated roller belt, air jets, etc.).

Evaluation unit 104 can then output information 144 that is indicative of the presence of a defect in the product. Information 144 can be output, for example, as an indication on a display or can also be transmitted to another device (e.g., a sorter) in the form of a control command. The other device can then be controlled, for example, based on this control command to reject further processing of the product for which the presence of a defect has been detected or to not carry out the further processing of this product.

In order to enable a detection of potential defects in the image of the product 130 as reliably as possible, it can advantageously be provided that the infrared light source 101 is a diffuse infrared light source. This prevents the image from having reflections (excessively bright or excessively dark areas in the infrared image) when the image is being created, which could erroneously be identified during the creation of the processed image as regions representing a defect. If a diffuse infrared light source 101 is not provided, it can alternatively be provided that a non-diffuse infrared light source is associated with a diffuser 111 that converts the infrared radiation emitted by the infrared light source into diffuse infrared radiation 110 before it passes the product and is detected by the infrared detector.

In FIG. 1, the infrared light source is arranged on the side of the infrared detector 102 disposed opposite the product. However, this arrangement is not mandatory like that. The assembly shown in FIG. 1 causes the product to be detected by the infrared detector in transmitted light. To ensure this, transport device 103 can be configured as a transparent (at least transparent to infrared radiation) transport device or can comprise a region that is transparent to infrared radiation, so that the irradiation of the products in transmitted light is possible.

Alternatively, it can also be provided (presently not shown) that the infrared light source is arranged on the same side of the product as infrared detector 102. In this case the infrared light source is arranged such that it emits the infrared light in the direction of product 130 and the reflected infrared light can be captured by infrared detector 102.

The infrared detector can comprise in particular a camera. An SWIR camera is particularly preferred so that well-resolved infrared images can be generated therewith at low costs.

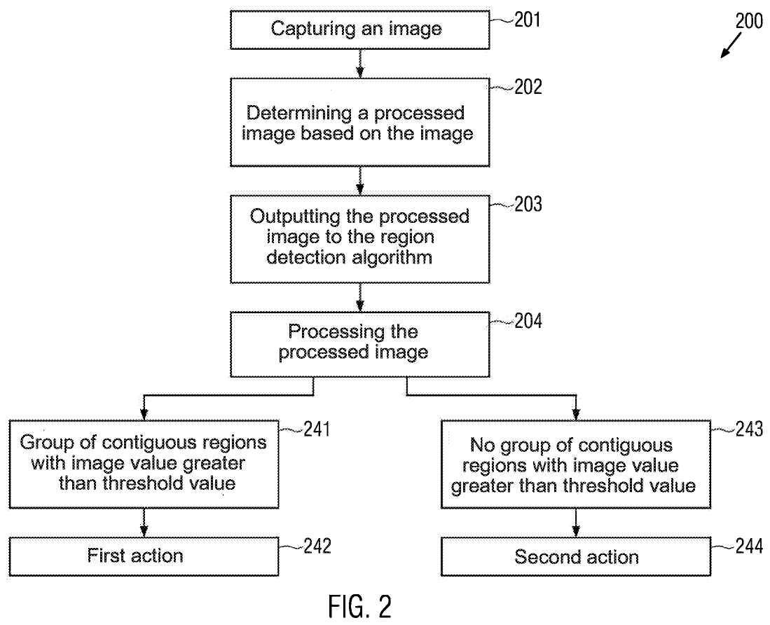

FIG. 2 shows a flow diagram of an embodiment of a method 200 for determining defects in a packaging unit and/or a product. As already set out above, reference will be made hereinafter only to determining and processing an image of a product, whereas the disclosure is not restricted in this respect and correspondingly also comprises capturing an image of packaging unit and/or a packaging unit with product filled therein.

The method begins with a step 201 in which an image of a product is captured in infrared light. As already described, this can take place either in backlight or reflected light and the disclosure is not restricted in this respect. The resolution of the image is in principle arbitrary, but can be as high as possible, for example, 1024×768 pixels or 2048×1080 pixels or similar.

This image is then made available to the evaluation unit which in step 202 creates a processed image based on the image. As already described, this processed image is not necessarily an image whose image information is identical to the originally captured image. Instead, the processed image can be present in the form of any data structure such as, for example, a matrix. The information of the processed image comprises at least one image value (for example, a gray value) that is associated with a specific region of the original image. For example, the data structure can associate a corresponding image value with each pixel of the image. Alternatively, the data structure or the processed image can also associate an image value with a sub-region of the original image respectively (for example, corresponding to a mean value of the image values of the original image). The sub-region can comprise a plurality of pixels of the original image, such as, for example, 4 pixels, 9 pixels, or 16 pixels. A corresponding image value is then jointly associated therewith in the processed image. The processed image is constructed at least such that each image value in the processed image is associated with a specific region of the original image (in particular its position) and the image information of the original image is retained in particular at least in part of the processed image or at least a part of the processed image comprises at least one image value that allows a bijective association of an image value of a corresponding region of the original image. If the original image consists, for example, of a matrix of pixels with pixel values Bᵢⱼ, then the processed image in the representation of a matrix can comprise matrix values Aᵢⱼ, wherein the indices i, j of the processed image are associated with the indices i, j of the pixels of the original image. This therefore means that, in the same arrangement of the pixels of the original image, “pixels” in the form of or comprising image values are present in the processed image for each corresponding pixel of the original image. This allows for later detection of regions of the image that indicate a defect, without the originally captured image being necessary for this.

The processed image is then passed to the region detection algorithm in step 203. As already described, the region detection algorithm can be configured as or comprise a blob algorithm and/or a contrast detection algorithm. The following description discusses a region detection algorithm that determines contiguous regions on the basis of identical image values and is therefore no contrast detection algorithm. However, these embodiments are equally applicable to a contrast detection algorithm with the proviso that the latter detects boundaries between contiguous groups on the basis of changes in contrast and not on the basis of matching image values. In this case, the change in contrast of adjacent regions is then compared. If this difference is below a limit value, it can be determined that the regions at issue represent parts of the product having equal quality. If the difference is greater than a threshold value, then the adjacent regions at issue belong to parts of the product having a different quality, which can then be used to detect that at least one of these regions is part of a defect.

The region detection algorithm processes the processed image in step 204. For this purpose, the region detection algorithm examines whether regions exist in the processed image that are contiguous, and for each region of this group of regions the associated image value is greater or less than a predefined threshold value.

In the sense of the preceding example of the processed image as a matrix, the regions are matrix entries Aᵢⱼ of the processed image. Contiguous regions in the processed image then arise from matrix entries that are each at least pairwise adjacent. Starting from a matrix entry Aᵢⱼ, adjacent regions or matrix entries in the sense of one embodiment are those with index i±1,j or i, j±1. Entries of the form A_{i±1j±1} can also be regarded as being adjacent, but are offset relative to the entry Aᵢⱼ in the diagonal of the matrix. In the original image, this means that these regions are only contiguous at a corner.

As an alternative to each of the regions having an image value greater or less than the threshold value, it can also be provided that an average image value of a contiguous group of regions in the processed image is greater or less than a given threshold value.

If the region detection algorithm detects a group of contiguous regions with an image value greater (or less) than the corresponding threshold value (step 241), a first action 242 can take place. This first action can be in particular the evaluation unit associating the presence of a defect to this group of contiguous regions. Additionally, this information can be, for example, output to an operator so that the operator can detect that a product has a defect. The operator can then, for example, remove this product from the transport device or operate a device (e.g., a sorter) that removes the correspondingly defective product from the transport device.

Alternatively, the information regarding the detected defect can also be used as a control signal for a device (e.g., a sorter) that can remove the defective product from the transport device.

It is understood that the region detection algorithm can also detect several groups of contiguous regions for which the image value is above (or below) a threshold value. This ultimately means that a product has several defects that are detected by the region detection algorithm. This does not change the further procedure, in particular the execution of first action 242. However, it can be provided that the evaluation unit stores the occurrence of defects and the number thereof per product and evaluates this over time. If a temporal evaluation detects, for example, that the frequency of defects and/or the number of defects on products increases over time (for example, a first number of products had on average a defect every hundredth product, but a second number of products examined at a later point in time had on average a defect every fifty products or two defects every twenty products), then the evaluation unit can also output this information to an operator, for example, as an average value for the determination of defects in a product and/or as an average value for the number of defects per product. The operator can then, for example, determine whether a deterioration has occurred in the operation of a device arranged upstream of the device for detecting defects and carry out corresponding steps of rectification (for example, maintenance work or repair work). The operator can also be prompted to do so by the evaluation unit by way of a corresponding information message.

If on the other hand the region detection algorithm detects for one product no group of contiguous regions whose respective image values are greater (or less) than the threshold value or whose average image value for the presence of a defect is greater than a corresponding threshold value (step 243), a second action 244 can take place. This second action 244 can comprise, for example, an updated display to an operator that the operation of the device is functioning properly. However, it can also be provided that second action 244 does not comprise an actual action, but simply causes the operation to continue.

It is understood that a distinction in the above embodiment between regions that are part of a defect and regions that are not part of a defect is done based on a determination that the regions have an image value greater or less than the threshold value. Whether regions with image values greater than the threshold value are to be assessed as indicating a defect or whether regions with image values less than the threshold value are to be assessed as a defect can be defined before or during commissioning, just like the actual numerical value of the threshold value. According to the disclosure, the distinction between regions indicating a defect and regions being part of a “normal” non-defect part of the product takes place in any case by way of the determination that image values of some regions being part of defects are “separated” from image values of regions not being part of defects by a threshold value of the image value such that a comparison of the image values with the threshold value allows for an association as to whether the respective region is part of a defect or not.

The method described in the context of FIG. 2 is preferably carried out for each product that is guided past the infrared detector so that each product is examined for defects.

Although, according to the above description, the processed image in principle allows for determining whether a given region could be part of a defect or not, whether the regions actually constitute defects can be reliably assessed only if “sufficiently many” contiguous regions comprise a corresponding image value indicative of a defect. If such groups of contiguous regions are not given, an individual region with a corresponding image value can also merely be an artifact in the original image without a defect being present. Correspondingly false negative detections of defects are avoided by the downstream evaluation of the processed image using the region detection algorithm. Because it examines a region that is larger as compared to the individual regions in the processed image for any deviations (since groups of contiguous regions in the processed image are identified that have image values above or below the threshold value). This reduces the risk that a defect is erroneously detected due to reflections or artifacts in the original image.

What is claimed is:

1. A device for detecting defects in a packaging unit and/or a product, the device comprising:
an infrared light source,
an infrared detector, and
an evaluation unit,
wherein the infrared detector and the infrared light source are arranged such that, in operation, the infrared detector captures an image of a packaging unit and/or a product in reflected light and/or transmitted light, and
wherein the evaluation unit is configured to process the image and to evaluate the processed image by a region detection algorithm and to determine whether a group of contiguous regions in the processed image has, for each region, an image value above or below a threshold value, and to output information indicative of a defect when at least one group of contiguous regions is present in the processed image for which each region has an image value above or below the threshold value.

2. The device according to claim 1, wherein the processed image comprises at least part of the image information of the image.

3. The device according to claim 1, wherein the image value is a gray value or a gray value difference of respectively adjacent pixels.

4. The device according to claim 1, wherein the region detection algorithm is a blob algorithm and/or a contrast detection algorithm.

5. The device according to claim 1, wherein the defects comprise one of a defective part of a product, a defective part of a packaging unit, a defective seal seam.

6. The device according to claim 1, wherein the regions are identical, wherein the regions are 16 pixels, 9 pixels, 4 pixels, or 1 pixel in size.

7. The device according to claim 1, wherein the device comprises a transport device for transporting packaging and/or products and wherein the transport device is arranged and configured such that, in operation, it guides packaging and/or products past the infrared light source and the infrared detector.

8. The device according to claim 1, wherein the infrared light source is a diffuse infrared light source or wherein the device comprises a diffuser to generate diffuse reflected light and/or backlight; and/or
wherein the infrared detector comprises a short-wave infrared camera.

9. The device according to claim 1, wherein the evaluation unit is further configured to control another device in response to information indicative of a defect such that processing of the packaging unit and/or product is rejected.

10. The device according to claim 9, wherein the evaluation unit is further configured to cause processing of the packaging unit and/or product to continue in an absence of information indicative of a defect.

11. A method for detecting defects in a packaging unit and/or a product by a device, the device comprising an infrared light source, an infrared detector, and an evaluation unit, the method comprising:
capturing an image of a packaging unit and/or a product in reflected light and/or transmitted light,
obtaining a processed image based on the image using the evaluation unit,
evaluating the processed image via the evaluation unit by a region detection algorithm of the evaluation unit and determining whether a group of contiguous regions in the processed image has, for each region, an image value above or below a threshold value, and
outputting information indicative of a defect when at least one group of contiguous regions is present in the processed image for which each region has an image value above or below the threshold value.

12. The method according to claim 11, wherein the processed image comprises at least part of the image information of the image.

13. The method according to claim 11, wherein the region detection algorithm is a blob algorithm and/or a contrast detection algorithm.

14. The method according to claim 11, wherein the defects comprise one of a defective part of a product, a defective part of a packaging unit, a defective seal seam.

15. The method according to claim 11, wherein the regions are identical, wherein the regions are 16 pixels, 9 pixels, 4 pixels, or 1 pixel in size.

16. The method according to claim 11, wherein the device comprises a transport device for transporting packaging and/or products and wherein the transport device guides packaging and/or products past the infrared light source and the infrared detector.

17. The method according to claim 11, wherein the infrared light source is a diffuse infrared light source or wherein the device comprises a diffuser to generate diffuse reflected light and/or backlight; and/or
wherein the infrared detector comprises a short-wave infrared camera.

18. The method of claim 11 further comprising rejecting processing of the packaging unit and/or product in response to information indicative of a defect.

19. The method of claim 18 further comprising continuing processing of the packaging unit and/or product in an absence of information indicative of a defect.
